(19) United States
(12) Patent Application Publication
(10) Pub. No.: US 2016/0182910 A1
(43) Pub. Date: Jun. 23, 2016

(54) VIDEO ENCODING APPARATUS AND VIDEO ENCODING METHOD

(71) Applicant: FUJITSU LIMITED, Kawasaki-shi (JP)

(72) Inventor: Guillaume Denis Christian Barroux, Kawasaki (JP)

(73) Assignee: FUJITSU LIMITED, Kawasaki-shi (JP)

(21) Appl. No.: 14/939,615

(22) Filed: Nov. 12, 2015

(30) Foreign Application Priority Data
Dec. 17, 2014 (JP) 2014-255535

(51) Int. Cl. H04N 19/147; H04N 19/103; H04N 19/124; H04N 19/172

(52) U.S. Cl. CPC H04N 19/147; H04N 19/172; H04N 19/103; H04N 19/124

(57) ABSTRACT

A video encoding apparatus includes: a frame encoder which encodes a field pair by a frame coding mode and calculates a first amount of coding and a first amount of distortion; a field encoder which encodes the field pair by a field coding mode and calculates a second amount of coding and a second amount of distortion; and a coding mode determining unit which applies the first amount of coding and the first amount of distortion to a reference function representing a relationship between the amount of coding and the amount of distortion to derive a first function, applies the second amount of coding and the second amount of distortion to the reference function to derive a second function, and determines the coding mode to be applied to the field pair, based on the magnitude relationship between the first function and the second function.

### CROSS-REFERENCE TO RELATED APPLICATION

This application is based upon and claims the benefit of priority of the prior Japanese Patent Application No. 2014-255535, filed on Dec. 17, 2014, the entire contents of which are incorporated herein by reference.

### FIELD

The embodiments discussed herein are related to a video encoding apparatus and a video encoding method.

### BACKGROUND

Generally, the amount of data used to represent video data is very large. Accordingly, an apparatus for handling such video data compresses the video data by encoding before transmitting the video data to another apparatus or before storing the video data in a storage device. Typical video coding standards widely used today include the Moving Picture Experts Group Phase 2 (MPEG-2), MPEG-4, and H.264 MPEG-4 Advanced Video Coding (H.264 MPEG-4 AVC) developed by the International Standardization Organization/International Electrotechnical Commission (ISO/IEC). A new video coding standard referred to as High Efficiency Video Coding (HEVC, MPEG-H/H.265) has been developed. These coding standards support two video formats, the interlaced video format and the progressive video format.

FIG. 1 is a diagram illustrating the relationship of fields in the interlaced video format with respect to frames in the progressive video format. Pictures in the progressive video format are referred to as frames or frame pictures. On the other hand, pictures in the interlaced video format are referred to as fields or field pictures. Video data conforming to the interlaced video format contains in alternating fashion a top field formed by extracting only data in odd-numbered lines from a corresponding frame and a bottom field formed by extracting only data in even-numbered lines. For example, as illustrated in FIG. 1, top fields 111 and 113 are generated by extracting odd-numbered lines from the corresponding frames 101 and 103 among the successive frames 101 to 104 contained in the video data conforming to the progressive video format and arranged in playback order. On the other hand, bottom fields 112 and 114 are generated by extracting even-numbered lines from the corresponding frames 102 and 104. A pair of a top field and a bottom field, one succeeding the other in playback order, will hereinafter be referred to as a field pair.

In the case of video with rapid motion, the spatial resolution that can be perceived by human vision drops. The interlaced video format takes advantage of this and reduces the amount of data without substantially impairing the subjective image quality perceived by the viewer. More specifically, in video data conforming to the interlaced video format, the vertical resolution of each picture is reduced by a factor of two compared to that in video data conforming to the progressive video format.

In MPEG-2 or in MPEG-4 AVC/H.264, a coding method that allows switching between a field coding mode and a frame coding mode on a picture-by-picture basis or slice-by-slice basis is employed so that video data conforming to the interlaced video format can be more efficiently encoded. The field coding mode is a coding mode in which the top and bottom fields in a field pair are encoded as separate fields. On the other hand, the frame coding mode is a coding mode in which a field pair is encoded by considering it as one frame. Such a coding method is referred to as Picture Adaptive Frame Field (PAFF) coding. In PAFF, different inter-frame prediction coding may be used when applying the field coding mode than when applying the frame coding mode by considering the difference between the frame and the field.

On the other hand, in H.264 MPEG-4 AVC, a coding method is employed that allows switching between the field coding mode and the frame coding mode on a macroblock pair basis, each pair containing two vertically adjacent macroblocks. Such a coding method is referred to as MacroBlock Adaptive Frame Field (MBAFF) coding. In HEVC, as in MPEG-2, etc., both the frame coding mode and the field coding mode can be applied to video data conforming to the interlaced video format. However, in HEVC, when the coding mode to be applied is switched between the frame coding mode and the field coding mode, a new sequence header is inserted at the switching point. Then, the vertical direction of the picture to be encoded is explicitly indicated by the sequence header. This is because, in HEVC, no distinction is made among the picture structures “top field,” “bottom field,” and “frame” when decoding the encoded video data.

Generally, the larger the amount of motion contained in a picture, the greater is the possibility that the field coding mode is applied, and the smaller the amount of motion contained in a picture, the greater is the possibility that the frame coding mode is applied, in order to increase the coding efficiency.

Techniques are proposed that use not only the evaluation value of the amount of coding but also error information, etc., in order to determine which coding mode, the field coding mode or the frame coding mode, is to be applied (for example, refer to Japanese Laid-open Patent Publication Nos. 2014-39095, 2008-283595, and 2011-66592). On the other hand, a method referred to as “rate distortion optimization” (RDO) is proposed as a method for appropriately determining the coding mode to be applied from among a plurality of coding modes (for example, refer to G. J. Sullivan, et al., “Rate Distortion Optimization for Video Compression,” IEEE Signal Processing Magazine, Vol. 15, Issue 6, pp. 74-90, 1998 (hereinafter referred to as non-patent document 1)).

### SUMMARY

When using the RDO method for the selection of a coding mode, the cost C is calculated, for example, in accordance with the following equation for each of a plurality of coding modes from among which to select the coding mode. Then, the coding mode that minimizes the cost C is selected.

C=λ·R+D (1)

where R is the rate, i.e., the amount of coding of a picture to be encoded or a block in the picture. D is the amount of distortion as error statistics before and after encoding, and is calculated, for example, as the sum of the squares of the differences between the original value of each pixel contained in the picture or slice to be encoded and the value of the corresponding pixel obtained by decoding the encoded picture or block. Further, λ is Lagrange's undetermined multiplier, and is represented, for example, by c*Q². Here, c is a constant which, for example, in H.264/AVC, is set to 0.85. On the other hand, Q is a quantization parameter which defines the quantization step size when quantizing orthogonal transform coefficients obtained by orthogonal-transforming each block within the picture.

FIG. 2 is a diagram illustrating examples of rate distortion curves. In FIG. 2, the horizontal line represents the rate R, and the vertical line represents the amount of distortion D. Curves 201 and 202 represent rate distortion curves for different coding modes, respectively. As can be seen from the curves 201 and 202, generally the rate distortion curve is convex downward, and the amount of distortion D monotonically decreases as the rate R increases.

The rate for the coding mode corresponding to the curve 201 (hereinafter referred to as the coding mode A for convenience) is denoted by R_{A}, and the amount of distortion by D_{A}. Similarly, the rate for the coding mode corresponding to the curve 202 (hereinafter referred to as the coding mode B for convenience) is denoted by R_{B}, and the amount of distortion by D_{B}. Then, it is assumed that the same λ, i.e., the same quantization parameter, is used for the calculation of the cost C_{A} for the coding mode A and the calculation of the cost C_{B} for the coding mode B. In this case, the cost C_{A} is given by the point at which a line 211 tangent to the curve 201 at the point of intersection (R_{A}, D_{A}) of the rate R_{A} and the amount of distortion D_{A} and having the slope λ intersects the vertical line. Likewise, the cost C_{B} is given by the point at which a line 212 tangent to the curve 202 at the point of intersection (R_{B}, D_{B}) of the rate R_{B} and the amount of distortion D_{B} and having the slope λ intersects the vertical line. In the example of FIG. 2, since the cost C_{B} is smaller than the cost C_{A}, the coding mode B corresponding to the cost C_{B} is selected.

However, there are cases in which the value of λ used for the calculation of the cost is different for each coding mode. For example, in PAFF, unlike in MBAFF, the quantization parameter used in the field coding mode may be different than that used in the frame coding mode. More specifically, a quantization parameter QFrame is used in the frame coding mode. On the other hand, in the field coding mode, different quantization parameters (QFirstField and QSecondField) may be used for the top and bottom fields, respectively. This is because different bit allocation strategies, for example, may be employed for different coding modes. If different quantization parameters are used for different coding modes, it follows that when λ is set based on the quantization parameter, different values of λ are used for different coding modes; as a result, when selecting a coding mode by the RDO method, an optimum coding mode may not necessarily be selected.

FIG. 3 is a diagram illustrating examples of rate distortion curves for the case where an optimum coding mode is not selected. In FIG. 3, the horizontal line represents the rate R, and the vertical line represents the amount of distortion D. Curve 301 is the rate distortion curve for the coding mode A (one of the frame coding mode and the field coding mode). Curve 302 is the rate distortion curve for the coding mode B (the other one of the frame coding mode and the field coding mode). In the example of FIG. 3, it is preferable to select the coding mode B as the optimum coding mode, since the curve 302 is located below the curve 301. However, if the value of the quantization parameter for the coding mode A is smaller than the value of the quantization parameter for the coding mode B, for example, the value λ_{A} used for the calculation of the cost for the coding mode A becomes smaller than the value λ_{B} used for the coding mode B. As a result, the cost C_{A} given by the point at which a line 311 tangent to the curve 301 at the point (R_{A}, D_{A}) and having the slope λ_{A} intersects the vertical line becomes smaller than the cost C_{B} given by the point at which a line 312 tangent to the curve 302 at the point (R_{B}, D_{B}) and having the slope λ_{B} intersects the vertical line. In this case, the coding mode A is selected. Further, if the cost for each coding mode is calculated by using the same λ irrespective of the quantization parameter, the coding mode corresponding to the lower rate distortion curve may not be selected unless the value of λ is properly set.

If a plurality of rate/distortion pairs are obtained for each quantization parameter by using a plurality of different quantization parameters for each coding mode, then the video encoding apparatus can obtain a rate distortion curve for each coding mode by approximation based on such pairs. In that case, the above-described problem does not occur. However, in reality, it is often the case that only one rate/distortion pair can be obtained for each coding mode due to limitations on the amount of computation or the time needed for encoding. In such cases, it is not possible obtain a rate distortion curve for each coding mode, and there is thus a need to be able to select an optimum coding mode based on one rate/distortion pair obtained for each coding mode.

According to one embodiment, a video encoding apparatus for encoding each field pair containing two successive fields and contained in video data conforming to an interlaced video format by either a frame coding mode in which the two fields are encoded as one frame or a field coding mode in which the two fields are encoded as separate fields is provided. The video encoding apparatus includes: a frame encoder which encodes the field pair by the frame coding mode, and which calculates a first amount of coding resulting from the encoding and a first amount of distortion representing error statistics associated with the encoding; a field encoder which encodes the field pair by the field coding mode, and which calculates a second amount of coding resulting from the encoding and a second amount of distortion representing error statistics associated with the encoding; a coding mode determining unit which applies the first amount of coding and the first amount of distortion to a reference function representing a relationship between the amount of coding and the amount of distortion to derive a first function representing a relationship between the amount of coding and the amount of distortion when the field pair is encoded by the frame coding mode, applies the second amount of coding and the second amount of distortion to the reference function to derive a second function representing a relationship between the amount of coding and the amount of distortion when the field pair is encoded by the field coding mode, and selects either the frame coding mode or the field coding mode as the coding mode to be applied to the field pair, based on a magnitude relationship between the first function and the second function; and an output unit which outputs the field pair encoded by the frame coding mode or the field coding mode, whichever is selected as the coding mode to be applied.

The object and advantages of the invention will be realized and attained by means of the elements and combinations particularly indicated in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the relationship of fields in an interlaced video format with respect to frames in a progressive video format.

FIG. 2 is a diagram illustrating examples of rate distortion curves.

FIG. 3 is a diagram illustrating examples of rate distortion curves for the case where an optimum coding mode is not selected.

FIG. 4 is a diagram schematically illustrating the configuration of a video encoding apparatus according to one embodiment.

FIG. 5 is an operation flowchart of a video encoding process according to the one embodiment.

FIG. 6 is a diagram illustrating the configuration of a computer that can implement the video encoding process according to the above embodiment or its modified example.

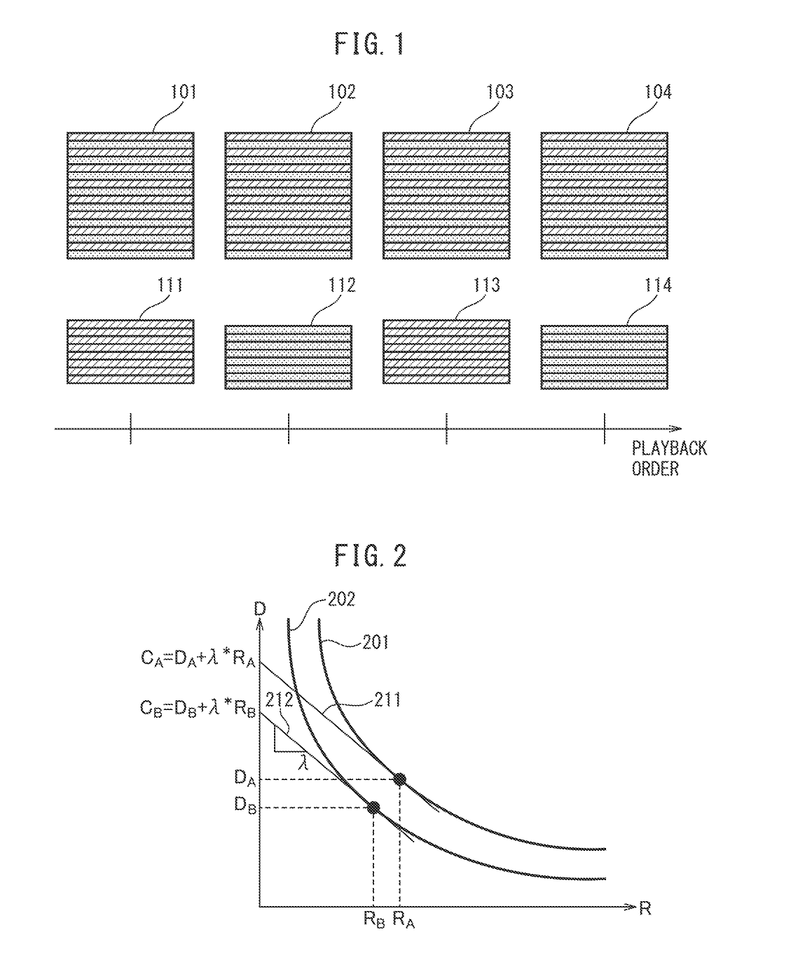

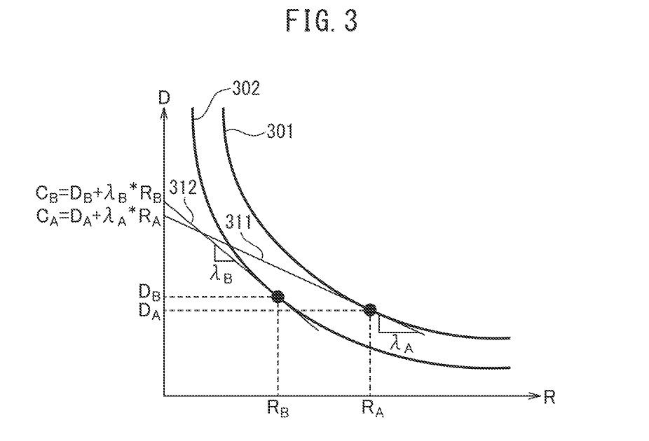

### DESCRIPTION OF EMBODIMENTS

A video encoding apparatus will be described below with reference to the drawings. The video encoding apparatus encodes each picture of video conforming to the interlaced video format in accordance with the PAFF method. More specifically, the video encoding apparatus first determines for each field pair the coding mode, the frame coding mode or the field coding mode, to be applied to the field pair. For this purpose, the video encoding apparatus obtains a rate distortion function for each coding mode by applying the rate and the amount of distortion obtained by encoding the field pair in the coding mode to a reference function representing the relationship between the rate and the amount of distortion. Then, based on the rate distortion function for each coding mode, the video encoding apparatus obtains the amount of distortion corresponding to a prescribed reference rate, and selects the coding mode yielding the smaller amount of distortion as the coding mode to be applied.

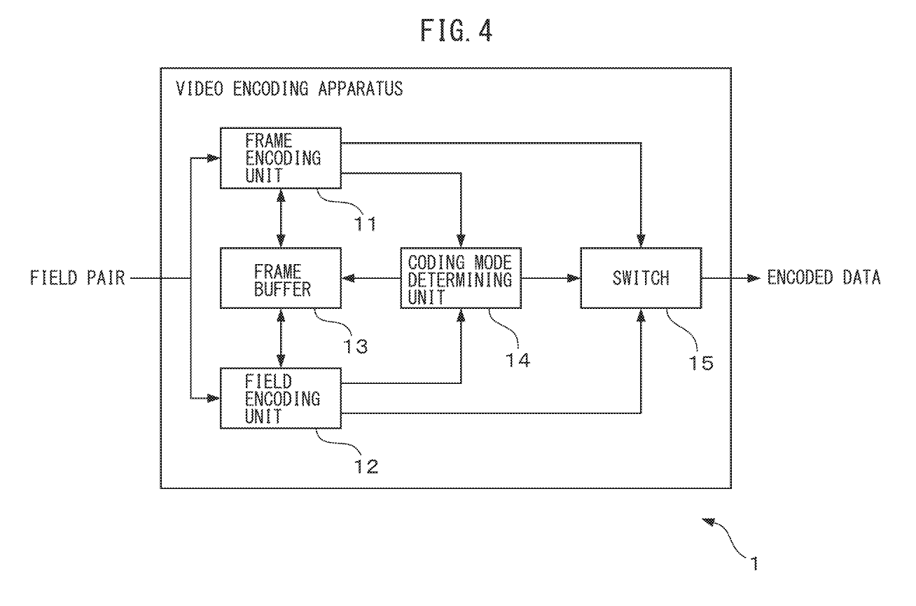

FIG. 4 is a diagram schematically illustrating the configuration of a video encoding apparatus according to one embodiment. The video encoding apparatus 1 includes a frame encoding unit 11, a field encoding unit 12, a frame buffer 13, a coding mode determining unit 14, and a switch 15. These units constituting the video encoding apparatus 1 are implemented as separate circuits. Alternatively, these units constituting the video encoding apparatus 1 may be implemented on the video encoding apparatus 1 in the form of a single integrated circuit on which the circuits corresponding to the respective units are integrated. Further alternatively, these units constituting the video encoding apparatus 1 may be implemented as functional modules by executing a computer program on a processor incorporated in the video encoding apparatus 1.

The video encoding apparatus 1 acquires encoding target video data conforming to the interlaced video format, for example, via a communication network and an interface circuit (not depicted) for connecting the video encoding apparatus 1 to the communication network. Then, the video encoding apparatus 1 stores the video data in a buffer memory (not depicted). The video encoding apparatus 1 accesses the buffer memory and sequentially reads out, in encoding order, each field pair contained in the video data. Then, the frame encoding unit 11 in the video encoding apparatus 1 encodes the field pair by the frame coding mode, and the field encoding unit 12 encodes the field pair by the field coding mode. After being encoded by each encoding unit, the field pair is decoded and stored in the frame buffer 13 so that it can be referred to when encoding a field pair that is later in encoding order. Then, the coding mode determining unit 14 in the video encoding apparatus 1 selects the frame coding mode or the filed coding mode in accordance with the RDO method as the coding mode to be applied to the field pair, and notifies the switch 15 of the selected coding mode. The switch 15 outputs data of the field pair encoded in the selected coding mode.

Each of units included in the video encoding apparatus 1 will be described in detail below. For convenience of explanation, it is assumed that each field pair is frame-coded or field-coded on a picture-by-picture basis, but the frame coding or field coding may be performed on a slice-by-slice basis or a tile-by-tile basis. The video encoding apparatus 1 encodes each field pair contained in video data in accordance with a coding standard, such as MPEG-2 or H.265, which allows the use of the PAFF method.

The frame encoding unit 11 encodes each field pair by treating the top and bottom fields contained in the field pair as one frame in accordance with the frame coding mode and in compliance with the coding standard to which the video encoding apparatus 1 conforms. When inter-predictive coding the field pair, the frame encoding unit 11 refers to a field pair stored in the frame buffer 13 and preceding in encoding order. The frame encoding unit 11 decodes the encoded field pair so that it can be referred to by a field pair succeeding in encoding order, and writes the decoded field pair into the frame buffer 13.

Further, the frame encoding unit 11 obtains the amount of distortion D_{Frame} as error statistics between the original unencoded field pair and the encoded and then decoded field pair, and the rate R_{Frame} as the amount of coding of the field pair. The frame encoding unit 11 calculates the amount of distortion D_{Frame}, for example, as the sum of the squares of the differences in corresponding pixels between the original unencoded field pair and the encoded and then decoded field pair. Alternatively, the frame encoding unit 11 may calculate the amount of distortion D_{Frame} as the sum of the absolute differences in corresponding pixels between the original unencoded field pair and the encoded and then decoded field pair. The frame encoding unit 11 notifies the coding mode determining unit 14 of the amount of distortion D_{Frame}, the rate R_{Frame}, and the quantization parameter Q_{Frame} applied to the field pair. Further, the frame encoding unit 11 supplies the data containing the encoded field pair to the switch 15.

The field encoding unit 12 encodes each field pair by treating the top and bottom fields contained in the field pair as two separate fields in accordance with the field coding mode and in compliance with the coding standard to which the video encoding apparatus 1 conforms. When inter-predictive coding the field pair, the field encoding unit 12 refers to a field pair stored in the frame buffer 13 and preceding in encoding order. The field encoding unit 12 decodes the encoded field pair so that it can be referred to by a field pair succeeding in encoding order, and writes the decoded field pair into the frame buffer 13.

Further, the field encoding unit 12 calculates for each field the amount of distortion D_{Field1}, D_{Field2} as error statistics between the original unencoded field and the encoded and then decoded field, and the rate R_{Field1}, R_{Field2} as the amount of coding of the field. Similarly to the frame encoding unit 11, the field encoding unit 12 calculates the amount of distortion D_{Field1}, D_{Field2} as the sum of the squares of the differences or the sum of the absolute differences in corresponding pixels between the original unencoded field and the encoded and then decoded field. The field encoding unit 12 notifies the coding mode determining unit 14 of the amount of distortion D_{Field1}, D_{Field2}, the rate R_{Field1}, R_{Field2}, and the quantization parameter Q_{Field1}, Q_{Field2} applied to each field. Further, the field encoding unit 12 supplies the data containing the encoded field pair to the switch 15.

The frame buffer 13 is a memory circuit which can be referred to from both the frame encoding unit 11 and the field encoding unit 12, and stores a predetermined number of most recently decoded field pairs in encoding order. The predetermined number is the number of field pairs that may potentially be referred to by the encoding target field pair in the coding standard to which the video encoding apparatus 1 conforms.

Between the field pair written from the frame encoding unit 11 and the field pair written from the field encoding unit 12, the field pair corresponding to the coding mode not to be applied may be erased from the frame buffer 13.

The coding mode determining unit 14 determines which coding mode, the frame coding mode or the field coding mode, is to be applied to the encoding target field pair.

In the present embodiment, based on the assumption that the rate distortion curve for each coding mode has a similar shape, the coding mode determining unit 14 can obtain a rate distortion function representing the relationship between the rate and the amount of distortion for each coding mode from a reference function representing the relationship between the rate and the amount of distortion. Then, based on the magnitude relationship between the rate distortion functions obtained for the respective coding modes, the coding mode determining unit 14 determines the coding mode to be applied.

The relationship between the rate and the amount of distortion is expressed, for example, by the following equation.

D_{M}=σ_{M}²·e^{-R}^{_{M}}^{/a}^{_{M}} (2)

where D_{M} is the amount of distortion for the unit of coding (for example, the field pair) in a given coding mode M, and R_{M} is the rate (amount of coding) for the unit of coding in the coding mode M. On the other hand, σ_{M} and σ_{M} are constants. For the derivation of the equation (2), refer to non-patent document 1.

The reference function which is determined based on the equation (2) and used to derive the rate distortion function in each coding mode will be described below. First, the equation (2) is substituted into the equation (1), and both sides are differentiated with respect to R_{M}, to yield the following equation.

λ_{M}=−δD_{M}/δR_{M} (3)

Next, substituting the equation (2) into the equation (3) and transforming it yields the following equation.

$$\begin{matrix}{λ}_{M} = {σ}_{M}^{2} \cdot {e}^{- {R}_{M} / {a}_{M}} / {a}_{M} \\ = {D}_{M} / {a}_{M}\end{matrix} \qquad ( 4 )$$

From the equations (4) and (2), the constants σ_{M} and a_{M} are expressed by the following equations.

$${σ}_{M}^{2} = {D}_{M} \cdot {e}^{{R}_{M} \text{/} ( \frac{{D}_{M}}{{λ}_{M}} )} \\ {a}_{M} = {D}_{M} / {λ}_{M} \qquad ( 5 )$$

When σ_{M} and σ_{M} expressed by the equations (5) are substituted into the equation (2), the rate distortion function representing the relationship of the amount of distortion D relative to a given rate R for the coding mode M is expressed by the following equation.

$$D = {f}_{M} ( R ) = {D}_{M} \cdot {e}^{{R}_{M} \text{/} ( \frac{{D}_{M}}{{λ}_{M}} )} \cdot {e}^{- R \text{/} ( \frac{{D}_{M}}{{λ}_{M}} )} \qquad ( 6 )$$

In other words, the rate distortion function for the frame coding mode and the rate distortion function for the field coding mode are both expressed by the equation (6). Accordingly, the equation (6) is one example of the reference function representing the relationship between the rate and the amount of distortion. Then, based on the equation (6), the coding mode determining unit 14 obtains the rate distortion function for each coding mode.

When the rate distortion function for each coding mode is obtained based on the equation (6), the rate distortion function that yields the smaller amount of distortion for the same reference rate is smaller than the other rate distortion function in terms of both the rate and the amount of distortion. Therefore, in the present embodiment, the coding mode determining unit 14 calculates the amount of distortion (the amount of virtual distortion) for a predetermined reference rate for each coding mode in accordance with the rate distortion function obtained from the equation (6) for each coding mode. Then, the coding mode determining unit 14 determines that the coding mode that yields the smaller amount of distortion is the coding mode to be applied.

In order to reduce the amount of computation in the coding mode determining unit 14, it is preferable that the rate calculated by either the frame encoding unit 11 or the field encoding unit 12 for the encoding target field pair is taken as the predetermined reference rate. When the reference rate is thus set, since the amount of distortion for one of the coding modes is already calculated by the frame encoding unit 11 or the field encoding unit 12, the amount of computation in the coding mode determining unit 14 can be reduced.

For the frame coding mode, λ_{Frame} (=c*Q_{Frame}²) can be used as the undetermined multiplier 4 in the above equation (6). Here, c is a constant which is, for example, 0.85. Q_{Frame} is a quantization parameter. On the other hand, in the field coding mode, different quantization parameters may be used for the top and bottom fields, respectively, as earlier described. In other words, the value of the undetermined multiplier λ used in the top field may be different from that used in the bottom field. In view of this, a method of how an optimal undetermined multiplier λ_{FieldOptimal} is determined in the field coding mode as the undetermined multiplier λ_{M} in the equation (6) will be described below.

As in the equation (2), λ_{FieldOptimal} is expressed by the following equation.

λ_{FieldOptimal}=−δD_{Field}/δR_{Field} (7)

where R_{Field} is the rate for the encoding target field pair when the field coding mode is applied. D_{Field} is the amount of distortion for the encoding target field pair when the field coding mode is applied. Since the pixels contained in the top field do not overlap any pixels contained in the bottom field, D_{Field} is expressed as the sum of the amount of distortion D_{Field1} for the top field and the amount of distortion D_{Field2} for the bottom field. Likewise, R_{Field} is expressed as the sum of the rate R_{Field1} for the top field and the rate R_{Field2} for the bottom field. Accordingly, the equation (7) can be transformed as follows.

λ_{FieldOptimal}=−δ(D_{Field1}+D_{Field2})/δ(R_{Field1}+R_{Field2}) (8)

When the undetermined multiplier for the top field is denoted by λ_{Field1}, the following equation is obtained from the equations (2) and (8).

$$\begin{matrix}{λ}_{Field 1} - {λ}_{FieldOptimal} = - δ {D}_{Field 1} / δ {R}_{Field 1} + δ ( {D}_{Field 1} + {D}_{Field 2} ) / \\ δ ( {R}_{Field 1} + {R}_{Field 2} ) \\ = ( \begin{matrix}- δ {D}_{Field 1} \cdot δ ( {R}_{Field 1} + {R}_{Field 2} ) + \\ δ {R}_{Field 1} \cdot δ ( {D}_{Field 1} + {D}_{Field 2} )\end{matrix} ) \text{/} \\ ( δ {R}_{Field 1} \cdot δ ( {R}_{Field 1} + {R}_{Field 2} ) ) \\ = ( - δ {D}_{Field 1} \cdot δ {R}_{Field 2} + δ {R}_{Field 1} \cdot δ {D}_{Field 2} ) / \\ ( δ {R}_{Field 1} \cdot δ ( {R}_{Field 1} + {R}_{Field 2} ) ) \\ = ( - δ {D}_{Field 1} / δ {R}_{Field 1} + δ {D}_{Field 2} / δ {R}_{Field 2} ) / \\ ( δ ( {R}_{Field 1} + {R}_{Field 2} ) / δ {R}_{Field 2} ) \\ = ( {λ}_{Field 1} - {λ}_{Field 2} ) \cdot ( δ {R}_{Field 2} / δ ( {R}_{Field 1} + {R}_{Field 2} ) )\end{matrix} \qquad ( 9 )$$

Likewise, when the undetermined multiplier for the bottom field is denoted by λ_{Field2}, the following equation is obtained from the equations (2) and (8).

λ_{Field2}−λ_{FieldOptimal}=(λ_{Field}−λ_{Field1})·(δR_{Field1}/δ(R_{Field1}+R_{Field2})) (10)

Combining the equations (9) and (10) yields the following equation.

(λ_{Field1}−λ_{FieldOptimal})/(λ_{Field2}−λ_{FieldOptimal})=−δR_{Field2}/δR_{Field1} (11)

Since the rate distortion curve for any given coding mode is expressed by the same function, the following relation holds.

δR_{Field2}/δR_{Field1}>0 (12)

From the equation (8), the following equation is obtained.

λ_{FieldOptimal}=−δD_{Field1}/δ(R_{Field1}+R_{Field2})−δD_{Field2}/δ(R_{Field1}+R_{Field2}) (13)

If it is assumed that the rate R_{Field1} for the top field is approximately equal to the rate R_{Field2} for the bottom field, then from the equation (13) the following equation is obtained.

$$\begin{matrix}{λ}_{FieldOptimal} = - δ {D}_{Field 1} / δ ( 2 {R}_{Field 1} ) - δ {D}_{Field 2} / δ ( 2 {R}_{Field 2} ) \\ = {λ}_{Field 1} / 2 + {λ}_{Field 2} / 2 \\ = ( {λ}_{Field 1} + {λ}_{Field 2} ) / 2\end{matrix} \qquad ( 14 )$$

Thus, the coding mode determining unit 14 sets the undetermined multiplier λ_{FieldOptimal} for the field coding mode equal to the average taken between the undetermined multiplier for the top field and the undetermined multiplier for the bottom field. In other words, the coding mode determining unit 14 sets the undetermined multiplier λ_{FieldOptimal} equal to (c*(Q_{FirstField}²+Q_{SecondField}²)/2), i.e., the value obtained by taking the average of the sum of the square of the quantization parameter Q_{FirstField} for the top field and the square of the quantization parameter Q_{SecondField} for the bottom field and multiplying the average by the constant c.

The rate distortion function for the frame coding mode, which is used to determine the coding mode to be applied, is derived from the equation (6) as follows.

$${D}_{FrameRef} = {e}^{- {R}_{Frame} \text{/} ( \frac{{D}_{Frame}}{{λ}_{Frame}} )} \cdot {e}^{- {R}_{Ref} \text{/} ( \frac{{D}_{Frame}}{{λ}_{Frame}} )} \qquad ( 15 )$$

On the other hand, the rate distortion function for the field coding mode, which is used to determine the coding mode to be applied, is derived from the equations (6) and (14) as follows.

$${D}_{FieldRef} = {e}^{- {R}_{Field} \text{/} ( \frac{{D}_{Field}}{{λ}_{FieldOptimal}} )} \cdot {e}^{- {R}_{Ref} \text{/} ( \frac{{D}_{Field}}{{λ}_{FieldOptimal}} )} \qquad ( 16 )$$

For the encoding target field pair, the coding mode determining unit 14 calculates, based on the equation (15), the amount of distortion (the first amount of virtual distortion) D_{RefFrame} for the reference rate R_{Ref} when the frame coding mode is applied. Further, for the encoding target field pair, the coding mode determining unit 14 calculates, based on the equation (16), the amount of distortion (the second amount of virtual distortion) D_{RefField} for the reference rate R_{Ref} when the field coding mode is applied. If D_{RefFrame} is smaller than D_{RefField}, the coding mode determining unit 14 determines that the coding mode to be applied is the frame coding mode. On the other hand, if D_{RefField} is smaller than D_{RefFrame}, the coding mode determining unit 14 determines that the coding mode to be applied is the field coding mode. If D_{RefFrame} is equal to D_{RefField}, the coding mode determining unit 14 may select either coding mode as the coding mode to be applied. Alternatively, if D_{RefFrame} is equal to D_{RefField}, the coding mode determining unit 14 may select the coding mode applied to the field pair immediately preceding in encoding order as the coding mode to be applied to the encoding target field pair.

The coding mode determining unit 14 notifies the switch 15 and the frame buffer 13 by sending information indicating which coding mode, the frame coding mode or the field coding mode, has been selected as the coding mode to be applied.

The switch 15 is one example of an output unit which, when the coding mode indicating information received from the coding mode determining unit 14 indicates the frame coding mode, outputs the encoded data of the field pair received from the frame encoding unit 11. On the other hand, when the coding mode indicating information received from the coding mode determining unit 14 indicates the field coding mode, the switch 15 outputs the encoded data of the field pair received from the field encoding unit 12.

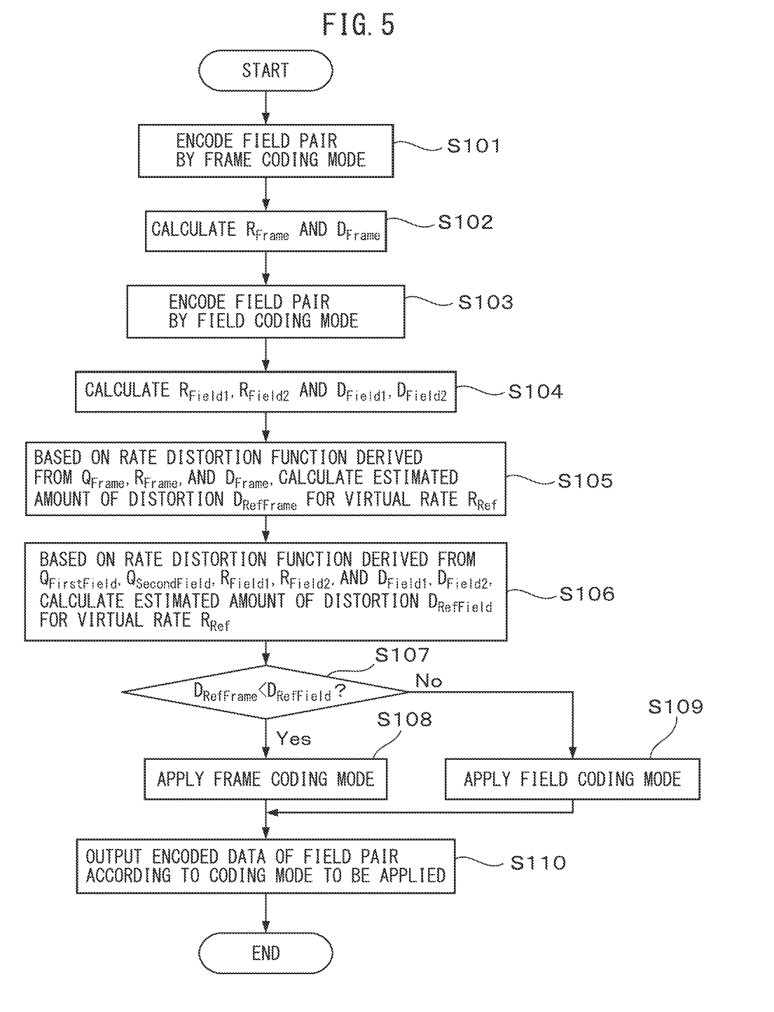

FIG. 5 is an operation flowchart of a video encoding process which is performed by the video encoding apparatus 1 according to the one embodiment. The video encoding apparatus 1 performs the video encoding process for each field pair.

The frame encoding unit 11 encodes the encoding target field pair by the frame coding mode (step S101). Then, the frame encoding unit 11 obtains the rate R_{Frame} and the amount of distortion D_{Frame} for the field pair (step S102). The frame encoding unit 11 supplies the encoded data of the field pair to the switch 15. Further, the frame encoding unit 11 writes the field pair decoded from the encoded data into the frame buffer 13. Then, the frame encoding unit 11 notifies the coding mode determining unit 14 of the rate R_{Frame}, the amount of distortion D_{F}, and the quantization parameter Q_{Frame} used to quantize the field pair.

The field encoding unit 12 encodes the encoding target field pair by the field coding mode (step S103). Then, the field encoding unit 12 obtains the rate R_{Field1} R_{Field2} and the amount of distortion D_{Field1}, D_{Field2} for each field contained in the field pair (step S104). The field encoding unit 12 supplies the encoded data of the field pair to the switch 15. Further, the field encoding unit 12 writes the field pair decoded from the encoded data into the frame buffer 13. Then, the field encoding unit 12 notifies the coding mode determining unit 14 of the rate R_{Field1}, R_{Field2}, the amount of distortion D_{Field1}, D_{Field2}, and the quantization parameter Q_{FirstField}, Q_{SecondField} used to quantize each field of the field pair.

The coding mode determining unit 14 applies the quantization parameter Q_{Frame}, the rate R_{Frame}, and the amount of distortion D_{Frame} to the equation (6) to obtain the rate distortion function when the frame coding mode is applied to the encoding target field pair. Then, using the rate distortion function, the coding mode determining unit 14 calculates the amount of distortion D_{RefFrame} for the predetermined reference frame R_{Ref} (step S105). Further, the coding mode determining unit 14 applies the quantization parameter Q_{FirstField}, Q_{SecondField}, the rate R_{Field1}, R_{Field2}, and the amount of distortion D_{Field1}, D_{Field2} to the equation (6) to obtain the rate distortion function when the field coding mode is applied to the encoding target field pair. Then, using the rate distortion function, the coding mode determining unit 14 calculates the amount of distortion D_{RefField} for the predetermined reference frame R_{Ref} (step S106).

The coding mode determining unit 14 determines whether D_{RefFrame} is smaller than D_{RefField} (step S107). When D_{RefFrame} is smaller than D_{RefField} (Yes in step S107), the coding mode determining unit 14 determines that the frame coding mode is the coding mode to be applied to the encoding target frame pair (step S108). On the other hand, when D_{RefFrame} is not smaller than D_{RefField} (No in step S107), the coding mode determining unit 14 determines that the field coding mode is the coding mode to be applied to the encoding target frame pair (step S109).

After step S108 or S109, the coding mode determining unit 14 notifies the switch 15 and the frame buffer 13 by sending information indicating the coding mode to be applied. The switch 15 selects the frame-coded field pair or the field-coded field pair according to the coding mode to be applied, and outputs the selected encoded data (step S110). Then, the video encoding apparatus 1 terminates the video encoding process.

As has been described above, when encoding each field pair contained in video data conforming to the interlaced video format in accordance with the PAFF method, the video encoding apparatus can select the appropriate coding mode in accordance with the RDO method. In particular, according to the video encoding apparatus, the rate distortion function for each coding mode is obtained based on the reference function representing the relationship between the amount of coding and the amount of distortion, and the amount of distortion obtained for one coding mode by using the rate distortion function is compared with the amount of distortion obtained for the other coding mode. Then, the video encoding apparatus selects the coding mode yielding the smaller amount of distortion for the predetermined reference rate as the coding mode to be applied. In this way, the video encoding apparatus can appropriately determine the coding mode to be applied, even if different quantization parameters are used between the frame coding mode and the field coding mode.

According a modified example, in order to determine the magnitude relationship between the rate distortion functions obtained for the respective coding modes, the coding mode determining unit 14 may obtain the minimum distance between the rate distortion function obtained for the frame coding mode (the equation (15)) and the origin at which the rate and the amount of distortion are both zero. Likewise, the coding mode determining unit 14 may obtain the minimum distance between the rate distortion function obtained for the field coding mode (the equation (16)) and the origin. Then, the coding mode determining unit 14 may select the coding mode corresponding to the shorter minimum distance as the coding mode to be applied to the encoding target field pair.

According another modified example, the coding mode determining unit 14 may obtain the undetermined multiplier λ_{FieldOptimal} for the field coding mode by weighted averaging of the undetermined multipliers λ_{Field1} and λ_{Field2} with the rate for the top field and the rate for the bottom field.

A computer program executable on a processor to implement the functions of each of units included in the video encoding apparatus according to the above embodiment or its modified example may be provided in the form recorded on a computer readable recording medium.

The video encoding apparatus according to the above embodiment or its modified example is used in various applications. For example, the video encoding apparatus is incorporated in a video camera, a video transmitting apparatus, a video receiving apparatus, a video telephone system, a computer, or a mobile telephone.

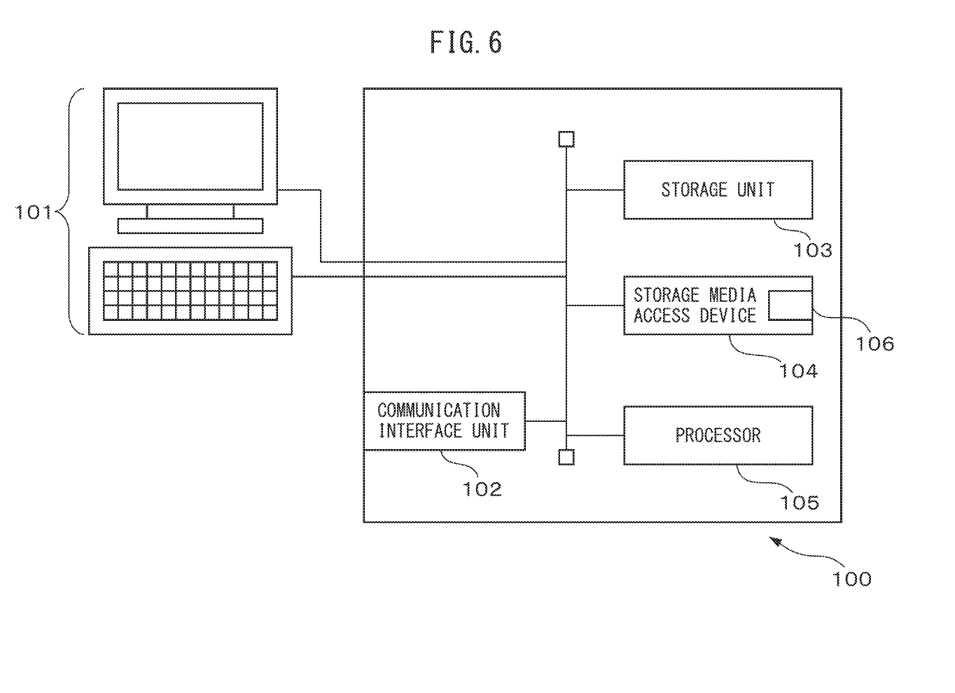

FIG. 6 is a diagram illustrating the configuration of a computer that operates as a video encoding apparatus by executing a computer program for implementing the functions of each of units included in the video encoding apparatus according to the above embodiment or its modified example. The computer 100 includes a user interface unit 101, a communication interface unit 102, a storage unit 103, a storage media access device 104, and a processor 105. The processor 105 is connected to the user interface unit 101, communication interface unit 102, storage unit 103, and storage media access device 104, for example, via a bus.

The user interface unit 101 includes, for example, an input device such as a keyboard and mouse and a display device such as a liquid crystal display. Alternatively, the user interface unit 101 may include a device, such as a touch panel display, into which an input device and a display device are integrated. The user interface unit 101 generates in response to a user operation an operation signal for initiating the video encoding process and supplies the operation signal to the processor 105.

The communication interface unit 102 may include a communication interface for connecting the computer 100 to a video input device such as a video camera (not depicted), and a control circuit for the communication interface. Such a communication interface may be, for example, a Universal Serial Bus (USB) interface.

Further, the communication interface unit 102 may include a communication interface for connecting to a communication network conforming to a communication standard such as the Ethernet (registered trademark), and a control circuit for the communication interface. In this case, the communication interface unit 102 acquires video data conforming to the interlaced video format from an image input device or another device connected to the communication network, and passes the video data to the processor 105. The communication interface unit 102 may receive encoded video data from the processor 105 and supply it to another apparatus via the communication network.

The storage unit 103 includes, for example, a readable/writable semiconductor memory and a read-only semiconductor memory. The storage unit 103 stores a computer program for implementing the video encoding process to be executed on the processor 105 and data such as the video data to be encoded or the video data encoded by the processor 105. The storage unit 103 may be made to function as the frame buffer 13 in the video encoding apparatus depicted in FIG. 4.

The storage media access device 104 is a device that accesses a storage medium 106 such as a magnetic disk, a semiconductor memory card, or an optical storage medium. The storage media access device 104 accesses the storage medium 106 to read out, for example, the video encoding computer program to be executed on the processor 105, and passes the readout program to the processor 105. The storage media access device 104 may also be used to write the video data encoded by the processor 105 to the storage medium 106.

The processor 105 encodes the video data by executing the video encoding computer program according to the above embodiment or its modified example. To that end, the processor 105 executes, for example, the processing of each unit, other than the frame buffer 13, that is included in the video encoding apparatus 1 illustrated in FIG. 4. Then, the processor 105 stores the encoded video data in the storage unit 103, or supplies it to another apparatus via the communication interface unit 102.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority and inferiority of the invention. Although the embodiments of the present invention have been described in detail, it should be understood that the various changes, substitutions, and alterations could be made hereto without departing from the spirit and scope of the invention.

What is claimed is:

1. A video encoding apparatus for encoding each field pair containing two successive fields and contained in video data conforming to an interlaced video format by either a frame coding mode in which the two fields are encoded as one frame or a field coding mode in which the two fields are encoded as separate fields, the apparatus comprising:
a frame encoder which encodes the field pair by the frame coding mode, and which calculates a first amount of coding resulting from the encoding and a first amount of distortion representing error statistics associated with the encoding;
a field encoder which encodes the field pair by the field coding mode, and which calculates a second amount of coding resulting from the encoding and a second amount of distortion representing error statistics associated with the encoding;
a coding mode determining unit which applies the first amount of coding and the first amount of distortion to a reference function representing a relationship between the amount of coding and the amount of distortion to derive a first function representing a relationship between the amount of coding and the amount of distortion when the field pair is encoded by the frame coding mode, applies the second amount of coding and the second amount of distortion to the reference function to derive a second function representing a relationship between the amount of coding and the amount of distortion when the field pair is encoded by the field coding mode, and selects either the frame coding mode or the field coding mode as the coding mode to be applied to the field pair, based on a magnitude relationship between the first function and the second function; and
an output unit which outputs the field pair encoded by the frame coding mode or the field coding mode, whichever is selected as the coding mode to be applied.

2. The video encoding apparatus according to claim 1, wherein the coding mode determining unit calculates in accordance with the first function a first amount of virtual distortion representing the amount of distortion when the amount of coding of the field pair is set to a predetermined amount of coding, calculates in accordance with the second function a second amount of virtual distortion representing the amount of distortion when the amount of coding of the field pair is set to the predetermined amount of coding, and wherein when the first amount of virtual distortion is smaller than the second amount of virtual distortion, determines that the frame coding mode is to be applied to the field pair, and when the second amount of virtual distortion is smaller than the first amount of virtual distortion, determines that the field coding mode is to be applied to the field pair.

3. The video encoding apparatus according to claim 2, wherein the predetermined amount of coding is the first amount of coding or the second amount of coding.

4. The video encoding apparatus according to claim 1, wherein the coding mode determining unit derives the second function by using, together with the second amount of coding and the second amount of distortion, an average value taken between the square of a first quantization parameter that defines a quantization step size for one of the two fields and the square of a second quantization parameter that defines a quantization step size for the other of the two fields, the first and second quantization parameters having been used when encoding the field pair by the field coding mode.

5. A video encoding method for encoding each field pair containing two successive fields and contained in video data conforming to an interlaced video format by either a frame coding mode in which the two fields are encoded as one frame or a field coding mode in which the two fields are encoded as separate fields, the method comprising:
encoding, by a processor, the field pair by the frame coding mode and to calculate a first amount of coding resulting from the encoding and a first amount of distortion representing error statistics associated with the encoding;
encoding, by the processor, the field pair by the field coding mode and to calculate a second amount of coding resulting from the encoding and a second amount of distortion representing error statistics associated with the encoding;
applying, by the processor, the first amount of coding and the first amount of distortion to a reference function representing a relationship between the amount of coding and the amount of distortion to derive a first function representing a relationship between the amount of coding and the amount of distortion when the field pair is encoded by the frame coding mode, applying the second amount of coding and the second amount of distortion to the reference function to derive a second function representing a relationship between the amount of coding and the amount of distortion when the field pair is encoded by the field coding mode, and selecting either the frame coding mode or the field coding mode as the coding mode to be applied to the field pair, based on a magnitude relationship between the first function and the second function; and
outputting, by the processor, the field pair encoded by the frame coding mode or the field coding mode, whichever is selected as the coding mode to be applied.

6. The video encoding method according to claim 5, wherein the selecting either the frame coding mode or the field coding mode as the coding mode to be applied to the field pair calculates in accordance with the first function a first amount of virtual distortion representing the amount of distortion when the amount of coding of the field pair is set to a predetermined amount of coding, calculates in accordance with the second function a second amount of virtual distortion representing the amount of distortion when the amount of coding of the field pair is set to the predetermined amount of coding, and wherein when the first amount of virtual distortion is smaller than the second amount of virtual distortion, determines that the frame coding mode is to be applied to the field pair, and when the second amount of virtual distortion is smaller than the first amount of virtual distortion, determines that the field coding mode is to be applied to the field pair.

7. The video encoding method according to claim 6, wherein the predetermined amount of coding is the first amount of coding or the second amount of coding.

8. The video encoding method according to claim 5, wherein the applying the second amount of coding and the second amount of distortion to the reference function to derive the second function derives the second function by using, together with the second amount of coding and the second amount of distortion, an average value taken between the square of a first quantization parameter that defines a quantization step size for one of the two fields and the square of a second quantization parameter that defines a quantization step size for the other of the two fields, the first and second quantization parameters having been used when encoding the field pair by the field coding mode.

9. A non-transitory computer-readable recording medium having recorded thereon a video encoding computer program that causes a computer to execute encoding each field pair containing two successive fields and contained in video data conforming to an interlaced video format by either a frame coding mode in which the two fields are encoded as one frame or a field coding mode in which the two fields are encoded as separate fields, the video encoding computer program that causes a computer to execute a process comprising:
encoding the field pair by the frame coding mode and calculating a first amount of coding resulting from the encoding and a first amount of distortion representing error statistics associated with the encoding;
encoding the field pair by the field coding mode and calculating a second amount of coding resulting from the encoding and a second amount of distortion representing error statistics associated with the encoding;
applying the first amount of coding and the first amount of distortion to a reference function representing a relationship between the amount of coding and the amount of distortion to derive a first function representing a relationship between the amount of coding and the amount of distortion when the field pair is encoded by the frame coding mode, applying the second amount of coding and the second amount of distortion to the reference function to derive a second function representing a relationship between the amount of coding and the amount of distortion when the field pair is encoded by the field coding mode, and selecting either the frame coding mode or the field coding mode as the coding mode to be applied to the field pair, based on a magnitude relationship between the first function and the second function; and
outputting the field pair encoded by the frame coding mode or the field coding mode, whichever is selected as the coding mode to be applied.
